(19) United States
(12) Patent Application Publication
(10) Pub. No.: US 2017/0076666 A1
(43) Pub. Date: Mar. 16, 2017

(54) DISPLAY DRIVING DEVICE, DISPLAY APPARATUS AND DISPLAY DRIVING METHOD

(71) Applicant: Futaba Corporation, Mobara-shi (JP)

(72) Inventors: Keisuke KAWANA, Mobara-shi (JP); Takehiro IIZAWA, Mobara-shi (JP); Yasuaki TAMAKI, Mobara-shi (JP)

(21) Appl. No.: 15/235,250

(22) Filed: Aug. 12, 2016

(30) Foreign Application Priority Data
Sep. 16, 2015 (JP) 2015-183284

(51) Int. Cl. G09G 3/3233

(52) U.S. Cl. CPC G09G 3/3233; G09G 2310/08; G09G 2320/0626

(57) ABSTRACT

A display driving device performs display drive based on display data on a display unit in which data lines connected to a plurality of pixels arranged in a column direction and scanning lines connected to a plurality of pixels arranged in a row direction are disposed and in which the pixels are arranged at respective intersections of the data lines and the scanning lines. The display driving device includes a data line driving unit configured to supply a constant current to the data lines for time periods corresponding to gradation values of pixels specified by the display data whenever the scanning lines are selected. The data line driving unit drives the data lines such that the constant current is supplied to all or a part of pixels, of which gradation values specified by the display data indicate non-emission, for a non-emission time period.

### FIELD OF THE INVENTION

The present disclosure relates to a display driving device, a display apparatus, and a display driving method. More particularly, the disclosure relates to a technology for driving a display panel in which a plurality of data lines and a plurality of scanning lines are provided and in which pixels are arranged at intersections of the data lines and the scanning lines.

### BACKGROUND OF THE INVENTION

As display panels for displaying an image, there are known a display apparatus that makes use of an OLED (Organic Light Emitting Diode) and a display apparatus that makes use of an LCD (Liquid Crystal Display). Many display apparatuses include a display unit in which data lines connected to a plurality of pixels arranged in a column direction and scanning lines connected to a plurality of pixels arranged in a row direction are disposed and in which the pixels are arranged at intersections of the data lines and the scanning lines. In the case of so-called line sequential scanning, a scanning line driver sequentially selects scanning lines, and a data line driver outputs a data line drive signal for one scanning line to each data line, whereby the display of each dot, i.e., each pixel is controlled.

Japanese Patent Application Publication No. H9-232074 discloses a technology in which, in order to improve the delay in the start of pixel light emission attributable to the parasitic capacitance of a display panel using a so-called cathode reset method, all scanning lines are temporarily connected to a reset potential when a scanning line is shifted to a next scanning line. Japanese Patent Application Publication No. 2001-188501 discloses a technology in which a constant current value is increased for a predetermined period from the start of current supply to an organic EL (Electroluminescence) device.

For example, in the case of a passive matrix driven OLED display apparatus, there is considered a driving method for driving data lines by a constant current and controlling gradation by a width (on period) of a data line drive signal of the constant current. In this case, luminance unevenness is generated due to a difference in the number of non-emitted pixels on each line, which results in deterioration of an image quality. In the case of driving the OLED display apparatus, the data lines are driven by the constant current and only selected scanning lines are grounded. Further, a parasitic capacitance exists in pixels between the data lines and the scanning lines and the parasitic capacitance is charged or discharged by the potential variation of the data lines and the scanning lines. It is considered that the charge/discharge affects the current for lighting the OLED and this leads to the luminance unevenness. In view of the above, the disclosure provides a technology for improving an image quality by reducing or solving the luminance unevenness.

### SUMMARY OF THE INVENTION

In accordance with an aspect, there is provided a display driving device for performing display drive based on display data on a display unit in which data lines connected to a plurality of pixels arranged in a column direction and scanning lines connected to a plurality of pixels arranged in a row direction are disposed and in which the pixels are arranged at respective intersections of the data lines and the scanning lines. The display driving device includes a data line driving unit configured to supply a constant current to the data lines for time periods corresponding to gradation values of pixels specified by the display data whenever the scanning lines are selected. The data line driving unit drives the data lines such that the constant current is supplied to all or a part of pixels, of which gradation values specified by the display data indicate non-emission, for a non-emission time period.

In general, the constant current is not supplied to the non-emitted pixels (data lines connected to the non-emitted pixels), so that the corresponding pixels are in a non-emission state. On the other hand, in the present disclosure, the constant current is supplied to data lines of all or a part of the non-emitted pixels for a certain period of time (non-emission time period).

In the display driving device described above, the non-emission time period may be a fixed time period.

In other words, regardless of the positions of the pixels in the display unit, the scanning lines and the data lines, the constant current is supplied to pixels having non-emission gradation values in the display data for the same time period as the non-emission time period.

In the display driving device described above, the non-emission time period may be shorter than a constant current supply period for pixels having a lowest gradation among lighting instruction values in the display data.

By supplying the constant current to the non-emitted pixels, the corresponding pixels emit light actually. At this time, the non-emission time period is set to be shorter than the constant current supply time period for the lighted pixels so that the lighting is hardly recognized visually. In this manner, the driving for the non-emitted pixels is distinguished from the driving for the emitted pixels.

In the display driving device described above, the non-emission time period may be shorter than or equal to a half of the constant current supply period for the pixels having the lowest gradation among the lighting instruction values in the display data.

In view of the display quality, it is important to supply the constant current to the non-emitted pixels for a time period in which they are visually recognized as non-emission. The constant current supply time period for the non-emitted pixels is set to be shorter than or equal to a half of the constant current supply period for the lowest gradation in the lighting state, so that they are visually recognized as non-emission.

In the display driving device described above, the non-emission time period may vary depending on an external command.

Since the non-emission time period can be updated by the external command, the non-emission time period can be controlled depending on, e.g., the display unit.

In accordance with another aspect, there is provided a display apparatus including: a display unit in which data lines connected to a plurality of pixels arranged in a column direction and scanning lines connected to a plurality of pixels arranged in a row direction are disposed and in which the pixels are arranged at respective intersections of the data lines and the scanning lines; a display driving unit configured to drive the data lines based on a display data; and a scanning line driving unit configured to apply a scanning line drive signal to the scanning lines. The display driving unit includes the configurations of the display driving device described above.

Accordingly, the display apparatus supplies the constant current to the data lines of the non-emitted pixels for a certain period of time (non-emission time period). In other words, the display apparatus including the above-described display driving device can reduce or eliminate the display unevenness.

In accordance with still another aspect, there is provided a display drive method for performing display drive based on display data on a display unit in which data lines connected to a plurality of pixels arranged in a column direction and scanning lines connected to a plurality of pixels arranged in a row direction are disposed and in which the pixels are arranged at respective intersections of the data lines and the scanning lines. The display drive method includes driving the data lines such that a constant current is supplied to the data lines for time periods corresponding to gradation values of pixels specified by a display data whenever the scanning lines are selected and also supplied to all or a part of pixels, of which gradation values specified by the display data indicate non-emission, for a non-emission time period.

In other words, the current is supplied to the non-emitted pixels to eliminate or reduce the luminance unevenness generated due to the difference in the number of non-emitted pixels on the respective lines.

In accordance with still another aspect, there is provided a display apparatus including: a display unit in which data lines connected to a plurality of pixels arranged in a column direction and scanning lines connected to a plurality of pixels arranged in a row direction are disposed and in which the pixels are arranged at respective intersections of the data lines and the scanning lines; a scanning line driving unit configured to apply a scanning line drive signal to the scanning lines; a display driving unit including a data line driving unit configured to supply a constant current to the data lines for time periods corresponding to gradation values of pixels specified by a display data whenever the scanning lines are selected; and a display operation control unit configured to supply the display data to the display driving unit. The display operation control unit converts the gradation values of the display data and supplies the converted gradation values to the display driving unit so that the data line driving unit supplies the constant current to all or a part of the pixels, of which gradation values specified by the display data indicate non-emission, for a non-emission time period.

The constant current can be supplied for a certain period of time (non-emission time period) to the data lines of all or a part of the non-emitted pixels by converting the display data in the display operation control unit for outputting the display data to the display driving unit.

With such configurations, the display quality can be improved by eliminating or reducing the luminance unevenness generated by luminance changes caused by the difference in the number of non-emitted pixels on the respective lines.

### BRIEF DESCRIPTION OF THE DRAWINGS

The objects and features of the disclosure will become apparent from the following description of embodiments, given in conjunction with the accompanying drawings, in which:

FIG. 1 is a block diagram of a MPU and a display apparatus according to a first embodiment;

FIG. 2 is an explanatory view equivalently showing an anode driver, a cathode driver, and a pixel in the display apparatus according to the first embodiment;

FIG. 3 is an explanatory view of a circuit configuration of the anode driver according to the embodiment;

FIG. 4 is an explanatory view of luminance changes on a display;

FIGS. 5A to 5C are explanatory views of the luminance changes with respect to the entire luminance and the number of non-emitted dots;

FIG. 6 is a block diagram of inner parts of a controller IC according to the embodiment;

FIG. 7 is a block diagram of a timing controller according to the embodiment;

FIGS. 8A and 8B are respectively explanatory views of a gradation table and a gradation control according to the embodiment;

FIGS. 9A and 9B are explanatory views of a scanning line drive signal and a data line drive signal according to the embodiment;

FIG. 10 is an explanatory view equivalently showing an anode driver, a cathode driver, and a pixel in a display apparatus according to a second embodiment;

FIG. 11 is a flowchart of a gradation table setting process according to a third embodiment;

FIGS. 12A and 12B are explanatory views of a display data according to a fourth embodiment; and

FIG. 13 is an explanatory view of a gradation table used in the fourth embodiment;

### DETAILED DESCRIPTION OF THE EMBODIMENTS

Hereinafter, embodiments will be described in the following order.

1. Configurations of display apparatus and display driving device according to first embodiment

2. Description on luminance variation generated on display

3. Display driving operation of first embodiment

4. Second Embodiment

5. Third Embodiment

6. Fourth Embodiment

7. Summary and modification

### 1. Configurations of Display Apparatus and Display Driving Device According to First Embodiment

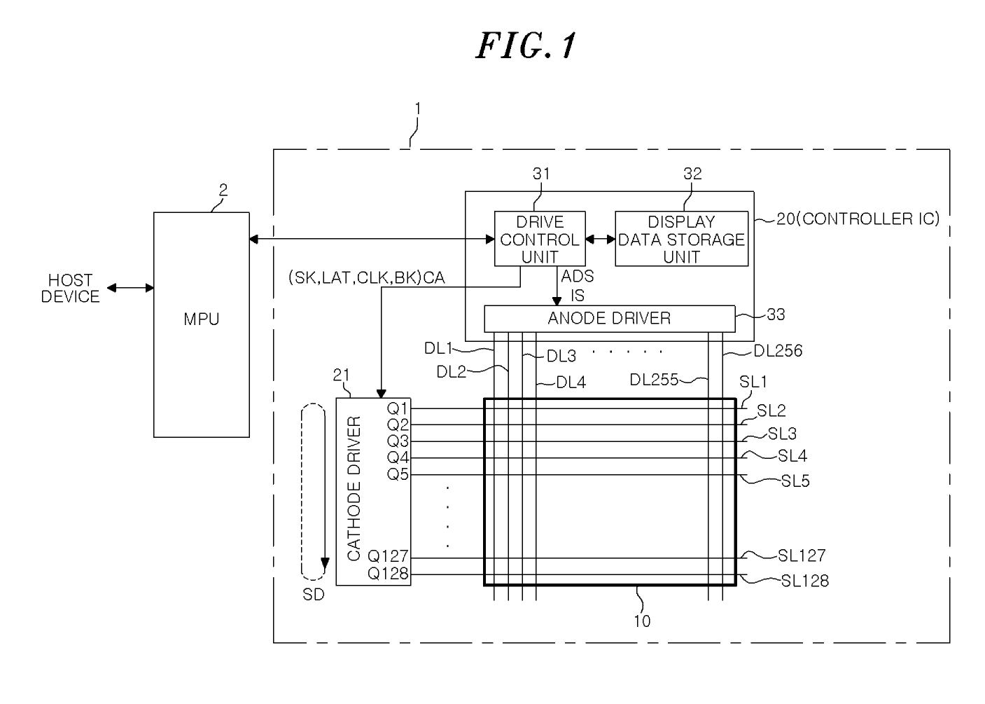

FIG. 1 shows a display apparatus 1 and a MPU (Micro Processing Unit: operation unit) 2 for controlling a display operation of the display apparatus 1. The display apparatus 1 includes a display unit 10 constituting a display screen, a controller IC (Integrated Circuit) 20, and a cathode driver 21. The MPU 2 may be included in the display unit 1. The display apparatus 1 shown in FIG. 1 (or the display apparatus 1 including the MPU 2) corresponds to a display apparatus defined in the claims. The controller IC 20 corresponds to a display driving device (or a display driving unit) defined in the claims.

In the display unit 10, a plurality of data lines DL and a plurality of scanning lines SL are arranged and pixels are disposed at the respective intersections of the data lines DL and the scanning lines SL. For example, 256 data lines (DL1 to DL256) and 128 scanning lines (SL1 to SL128) are disposed, so that 256 pixels are arranged horizontally and 128 pixels are disposed vertically. Accordingly, the display unit 10 includes 32768 (256×128) pixels forming a display image. In the present embodiment, each pixel is formed of a self-luminous element which makes use of an OLED. The number of pixels, the number of data lines and the number of scanning lines are merely an example. Each of the 256 data lines DL1 to DL256 is connected to the 128 pixels arranged in the column direction (vertical direction) in the display unit 10. Each of the 128 scanning lines SL1 to SL128 is connected to the 256 pixels arranged in the row direction (horizontal direction). A data line driving signal based on display data (gradation values) is applied from the data lines DL to 256 pixels on a selected scanning line SL, so that the respective pixels of the corresponding line are driven to emit light at the luminance (gradation) corresponding to the display data. The term “line” denotes a unit of a single scanning line and 256 pixels connected thereto.

The controller IC 20 and the cathode driver 21 are provided for the display drive of the display unit 10. The controller IC 20 includes a drive control unit 31, a display data storage unit 32 and an anode driver 33. The anode driver 33 drives the data lines DL1 to DL256. In this example, the anode driver 33 outputs a constant current to the data lines DL for a time period specified by a drive control signal ADS applied from the drive control unit 31, the drive control signal ADS being a pulse signal having a time period corresponding to the gradation. The constant current signal applied to the data lines DL is referred to as a “data line drive signal”. In other words, the display apparatus 1 in this example is a passive matrix driven OLED display apparatus and employs a driving method in which the gradations are controlled by a width (on period) of the data line drive signal of the constant current by performing the constant current drive on the data line DL.

The drive control unit 31 performs communication of a command and display data with the MPU 2, thereby controlling a display operation pursuant to the command. For example, upon receiving a display start command, the drive control unit 31 performs timing setting pursuant to the display start command and causes the cathode driver 21 to start scanning of the scanning lines SL by applying the cathode drive control signal CA to the cathode driver 21. Further, the drive control unit 31 causes the anode driver 33 to perform the driving of the 256 data lines DL in synchronization with the scanning performed by the cathode driver 21. As for the driving of the data lines DL performed by the anode driver 33, the drive control unit 31 causes the display data storage unit 32 to store the display data received from the MPU 2 and transmits the drive control signal AD based on the display data to the anode driver 33 in conformity with the scanning timing. In response, the anode driver 33 outputs the data line drive signal attributable to the gradations to the data lines DL. By virtue of this control, the respective pixels on the selected scanning line, i.e., one scanning line SL to which a scanning line drive signal of a selected level is applied from the cathode driver 21, are driven to emit light. The respective scanning lines are sequentially driven to emit light, whereby frame image display is realized. A current value of the data line drive signal outputted from the anode driver 33 is set by a current value control signal IS from the drive control unit 31.

The cathode driver 21 serves as a scanning line driving unit that applies a scanning line drive signal to one end of the scanning line SL. Output terminals Q1 to Q128 of the cathode driver 21 are connected to the scanning lines SL1 to SL128, respectively. As indicated by a scanning direction SD, a scanning line drive signal of a selected level is outputted sequentially from the output terminals Q1 to Q128, so that scanning is performed to sequentially select the scanning lines SL1 to SL128.

In order to perform this scanning, the drive control unit 31 supplies cathode driver control signals CA to the cathode driver 21. The cathode driver control signals CA comprehensively indicate various kinds of signals for the scanning control. For example, the cathode driver control signals CA include a scan signal SK, a latch signal LAT, a clock signal CLK and a blanking signal BK. While not described in detail, the cathode driver 21 includes a shift register (not shown) installed therein. The shift register transmits, based on the clock signal CLK, a signal of selected level applied as the scan signal SK sequentially from the output terminal Q1 to the output terminal Q128. The outputs of the shift register are latched to a latch circuit (not shown) by the latch signal LAT. The outputs of the latch circuit through a drive circuit (not shown) are transmitted from the output terminals Q1 to Q128 to the respective scanning lines SL1 to SL128.

By virtue of this operation, the cathode driver 21 performs scanning to sequentially select the scanning lines SL1 to SL128. The blanking signal BK is a signal that defines a timing at which the pixels are not driven to emit light.

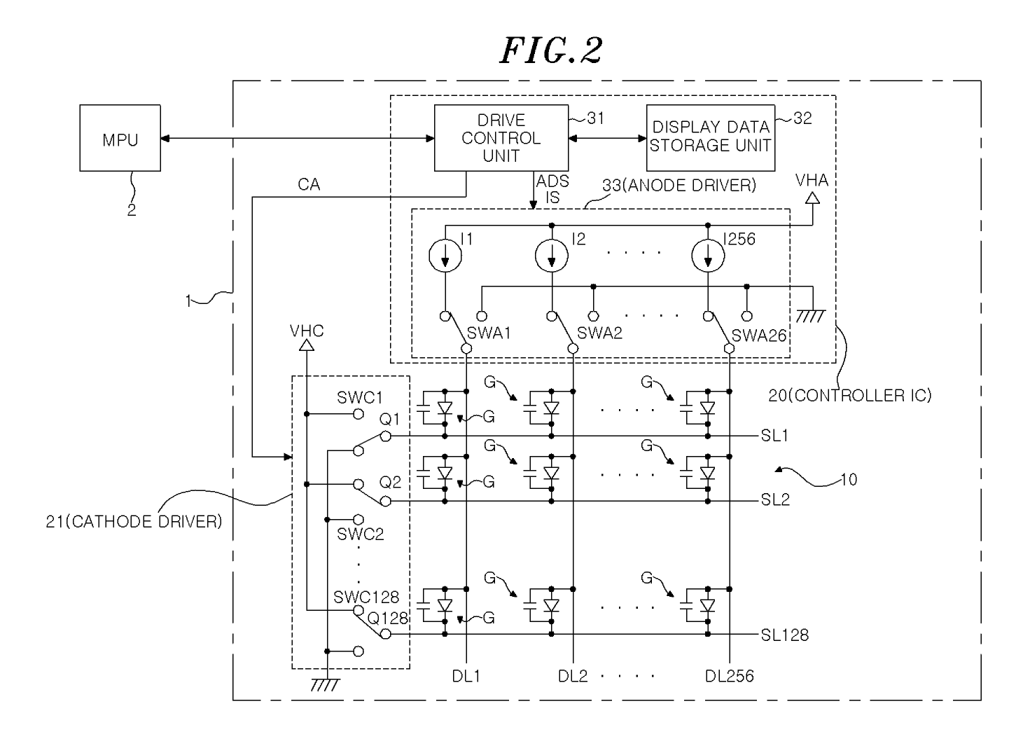

FIG. 2 shows, as an equivalent circuit, a configuration of the display unit 10, the anode driver 33 and the cathode driver 21. As shown in FIG. 2, the pixels G are arranged at the intersections of the data lines DL and the scanning lines SL in the display unit 10 and a display image is formed by the pixels G arranged in a matrix pattern. In FIG. 2, the pixels G are indicated by a diode symbol for an OLED and a capacitance symbol for a parasitic capacitance.

The cathode driver 21 is provided with switches SWC1 to SWC128 for selecting whether to connect the scanning lines SL1 to SL128 to the voltage VHC or the ground. A scanning line SL in a non-selected state is connected to the voltage VHC, and a selected scanning line SL is connected to the ground. In other words, in this case, a selected scanning line is in a ground potential state. By sequentially connecting the scanning lines SL1 to SL128 to the ground, the scanning lines SL1 to SL128 are sequentially selected.

In the anode driver 33, constant current sources I1 to I256 and switches SWA1 to SWA256 are provided to correspond to the data lines DL1 to DL256. In each of the data lines DL1 to DL256, the switches SWA1 to SWA256 are controlled by the drive control signal ADS such that the constant current (data line drive signal) from the constant current sources I1 to I256 is applied to the 256 pixels G of the selected scanning line SL for time periods corresponding to the display data (gradation values).

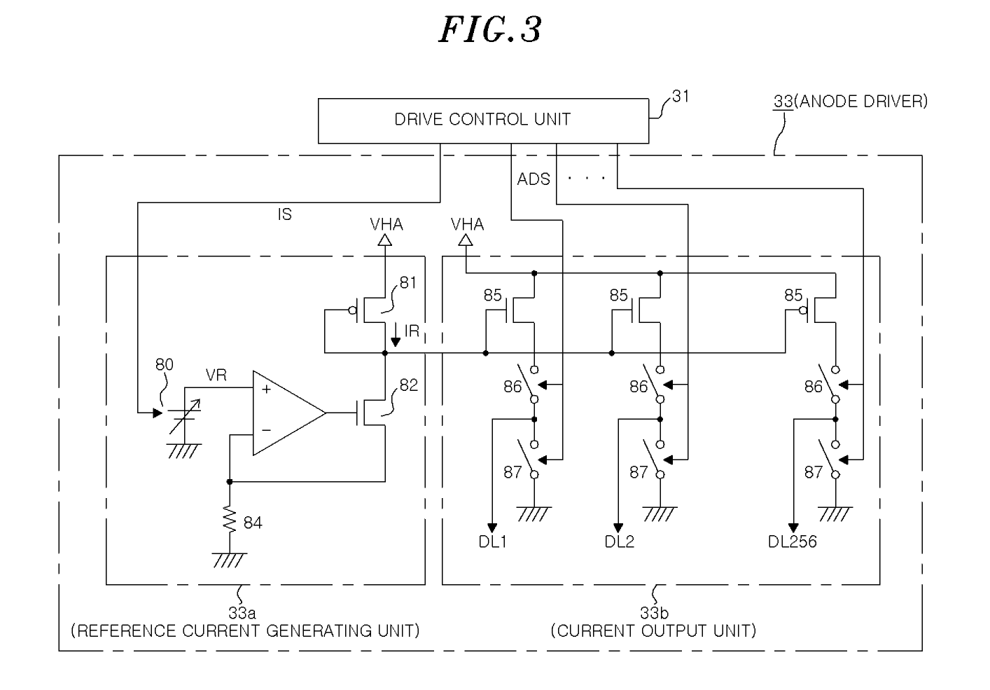

FIG. 3 shows a more specific configuration example in which the anode driver 33 supplies the constant current as the data line drive signal having the set current value to the data lines DL1 to DL256 for time periods corresponding to the gradations of the respective pixels. The anode driver 33 includes a reference current generating unit 33a and a current output unit 33b. The reference current generating unit 33a has a voltage varying unit 80, a differential amplifier 83, a P-channel FET (Field Effect Transistors) 81, an N-channel FET 82 and a resistor 84. A voltage VR is applied to a non-inverting input terminal of the differential amplifier 83. An inverting input terminal of the differential amplifier 83 is grounded via the resistor 84. The voltage VR of the voltage varying unit 80 is variably controlled by a current value control signal IS. An output terminal of the differential amplifier 83 is connected to a gate of the FET 82. A source of the FET 82 is connected to the inverting input terminal of the differential amplifier 83. A drain of the FET 82 is connected to the inverting input terminal of the differential amplifier 83.

A gate of the FET 81 is connected to the drain of the FET 81, a source of the FET 81 is connected to a voltage VHA, and a drain of the FET 81 is connected to a drain of the FET 82. With this configuration, a reference current IR corresponding to the voltage VR flows between the source and the drain of the FET 81. In other words, the current value of the reference current IR is variably controlled by the current value control signal IS.

The current output unit 33b, P-channels FET 85 and switches 86 and 87 for switching a state in which the data lines DL are connected to a current source and a state in which the data lines DL are connected to the ground are provided to correspond to the data lines DL1 to DL256. The source of the FET 85 is connected to the voltage VHA and the drain of the FET 85 is connected to the switch 86. The gate of the FET 85 is connected to the drain and the gate of the FET 81. By setting the switch 86 to an on state and the switch 87 to an off state, the data lines DL1 to DL256 are connected to the drain of the FET 85. By setting the switch 86 to an off state and the switch 87 to an on state, the data lines DL1 to DL256 are connected to the ground. In this case, the FET 81 and the FET 85 employ a current mirror configuration. Thus, when the switch 86 is in an on state and the switch 87 is in an off state, the data line drive signal IR that is the constant current signal of the current value of the reference current is applied to the data line DL. The switches 86 and 87 are switched between an on state and an off state by the drive control signal ADS from the drive control unit 31. For example, when the switch 86 is formed of a P-channel FET and the switch 87 is formed of an N-channel FET, the constant current is supplied to the data line DL during an L (Low) level of the drive control signal ADS and the data line DL is grounded during an H (High) level of the drive control signal ADS.

As can be understood from the above configuration, the constant current value as the data line drive signal applied to the data line DL is variably set by the current value control signal IS. The time period in which the data line drive signal is applied to the data line DL is controlled by the drive control signal ADS. Since the drive control signal ADS is the pulse signal having a width corresponding to the gradation value, the period in which the constant current (data line drive signal) is supplied to the data line DL is controlled by the gradation value and the pixels G emit light at the luminance corresponding to the gradation. In comparing the anode driver 33 shown in FIG. 3 with the anode driver 33 shown in FIG. 2, a pair of the switches 86 and 87 in FIG. 3 corresponds to the switches SWA1 to SWA256 in FIG. 2, and the other configurations in FIG. 3 correspond to the constant current sources I1 to I256 in FIG. 2.

### 2. Description on Luminance Variation Generated on Display

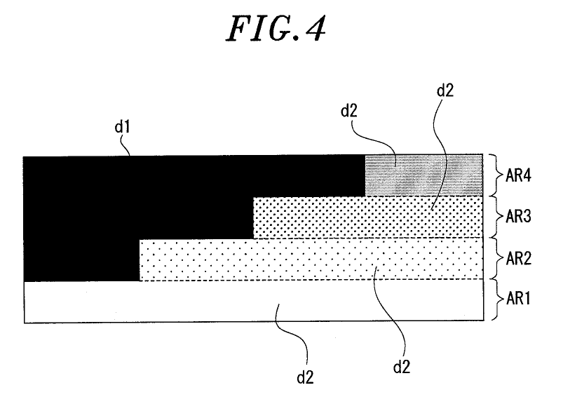

Next, the luminance variation generated on the display will be described. FIG. 4 schematically shows the luminance unevenness on the display. A display screen is divided into regions AR1 to AR4. Each of the regions AR1 to AR4 has a certain number of lines. For example, the region AR4 has the scanning lines SL1 to SL32; the region AR3 has the scanning lines SL33 to SL64; the region AR2 has the scanning lines SL65 to SL96; and the region AR1 has the scanning lines SL97 to SL128. Two types of gradations, i.e., a non-emission gradation value and an emission gradation value, are displayed. The non-emitted pixels are arranged in a region d1. For example, on the assumption that 256 gradations are displayed, a gradation value in the region d1 is 0/255. The pixels that emit light at a certain gradation value x/255 are arranged in a region d2. x is selected among 1 to 255, and x is, e.g., 128 or the like. Each line of the region AR1 emits light at the gradation value x/255. In each line of the region AR2, 1/4 pixels on a single line do not emit light (0/255) and 3/4 pixels emit light at the gradation value x/255. In each lines of the region AR3, 1/2 pixels on a single line do not emit light (0/255) and 1/2 pixels emit light at the gradation value x/255. In each line of the region AR4, 3/4 pixels on a single light do not emit light (0/255) and 1/4 pixels emit light at the gradation value x/255. The emitted pixels in the respective regions AR1 to AR4 emit light at the same gradation x/255. However, the luminance difference is generated as schematically shown in the drawing. In other words, the emitted pixels become bright on a line having a small number of non-emitted pixels and become dark on a line having a large number of non-emitted pixels. In this manner, the luminance variation occurs due to the difference in the lighting ratios of the respective lines. Here, the lighting ratio is given by the following equation:

Lighting ratio=(the number of emitted pixels on a single line)/(the total number of pixels on a single line).

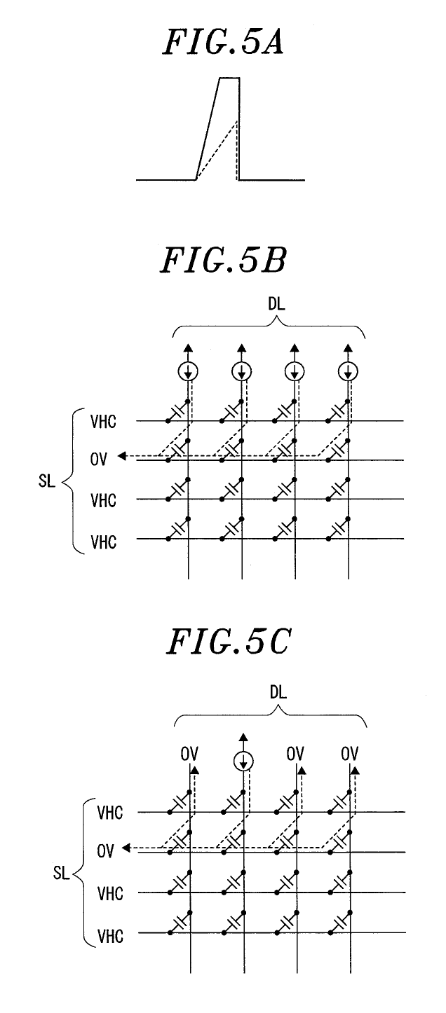

The causes of the luminance unevenness are as follows. FIG. 5B shows a model of a line having a high lighting ratio and also shows a state in which a light-emitting drive current is applied to all the data lines DL. The scanning lines SL of the voltage VHC are in a non-selected state and the scanning lines SL of a voltage 0V are in a selected line. In this case, a current applied to the respective data lines flows through the selected scanning line SL as indicated by broken lines.

FIG. 5C shows a model of a scanning line having a low lighting ratio and also shows a state in which a current is applied to a part of the data lines DL and the remaining data lines are kept at 0V (e.g., grounded). In this case, the current applied to the data line DL corresponding to the emitted pixels flows through not only the selected scanning line SL but also the data lines DL corresponding to the non-emitted pixels, as indicated by broken lines. For that reason, charging is performed with respect to the parasitic capacitance of the non-emitted pixels among the capacitance components of the respective pixels indicated by a capacitor symbol. Therefore, the load is increased. As a result, the rise of the light-emitting drive current is delayed.

In view of the foregoing, the light-emitting drive current applied to the pixels of the region AR1 shown in FIG. 4 where the lines having a high lighting ratio exist has a waveform indicated by a solid line in FIG. 5A and the light-emitting drive current applied to the pixels of the region AR4 where the lines having a low lighting ratio exist has a waveform indicated by a broken line in FIG. 5A. Specifically, the light-emitting drive current applied to the emitted pixels of the lines having a high lighting ratio rises fast and the light-emitting drive current applied to the emitted pixels of the lines having a low lighting ratio rises slow. This is considered to result in the luminance unevenness shown in FIG. 4.

### 3. Display Driving Operation of First Embodiment

In the first embodiment, the constant current is supplied as the data line drive signal to the non-emitted pixels for a short time period in order to deal with the luminance unevenness generated as described above. Hereinafter, the configuration required therefor will be described. The display data DT described in the first and the second embodiment is data having a predetermined bit number indicating a gradation value of each pixel which is transmitted from the MPU 2 to the controller IC 20.

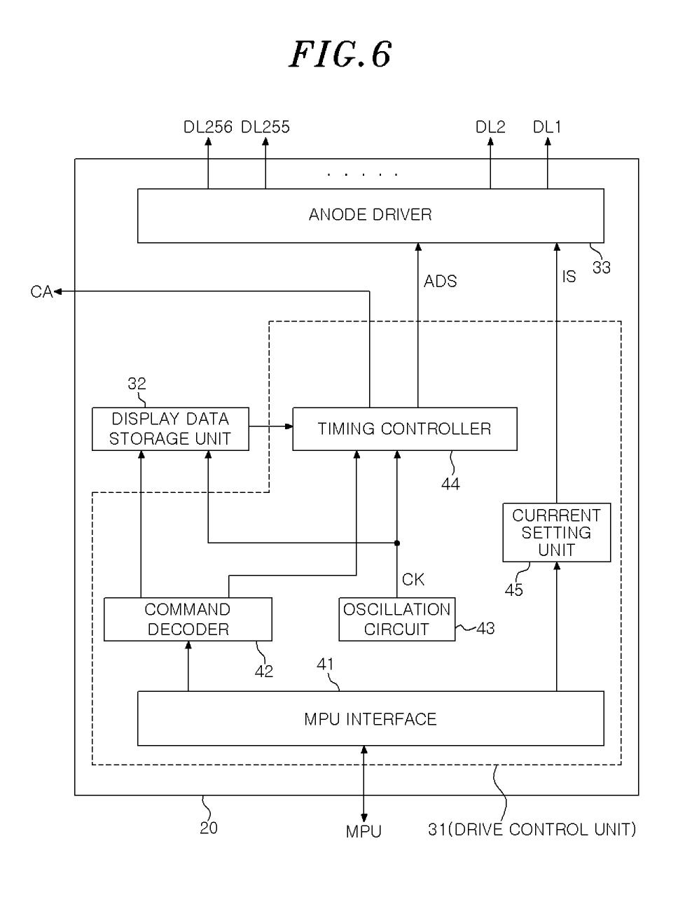

FIG. 6 shows inner parts of the controller IC 20 serving as a display driving device. Particularly, the drive control unit 31 is illustrated in detail. In the drive control unit 31, there are provided an MPU interface 41, a command decoder 42, an oscillation circuit 43, a timing controller 44, and a current setting unit 45.

The MPU interface 41 is an interface circuit unit for performing various types of communication with the MPU 2. Specifically, the display data, the command signal and the luminance set value are transmitted and received between the MPU interface 41 and the MPU 2. The command decoder 42 inputs the command signal transmitted from the MPU 2 into an internal register (not shown) and decodes the command signal. The command decoder 42 sends a necessary notice to the timing controller 43 so that an operation determined by the content of the recorded command signal can be executed. The command decoder 42 stores the inputted display data in the display data storage unit 32.

The oscillation circuit 43 generates a clock signal CK for display drive control. The clock signal CK is supplied to the display data storage unit 32 and used as a clock of a data recording/reading operation. Further, the clock signal CK is used for processing of the timing controller 44.

The current setting unit 45 receives the instructed luminance setting value from the MPU 2 via the MPU interface 41. The current value control signal IS is supplied to the anode driver 33 in response to the instructed luminance setting value. As described in FIG. 3, the constant current value as the data line drive signal is controlled by the current value control signal IS. In other words, the display unit 10 can perform the control (dimming control) of the entire luminance of the screen in response to the instruction from the MPU 2.

The timing controller 43 sets the drive timing of the scanning lines SL and the data lines DL of the display unit 10. Further, the timing controller 43 outputs the cathode driver control signals CA so that the cathode driver 21 executes the line scanning. Moreover, the timing controller 43 outputs the drive control signal ADS to the anode driver 33 so that the anode driver 33 executes driving of the data lines DS (output of the constant current as the data line drive signal). To do so, the display data is read out from the display data storage unit 32 and the drive control signal ADS is generated based on the display data. Accordingly, at the scan timing of each scanning line, the anode driver 33 performs the output of the constant current (data line drive signal) to the pixels of the corresponding scanning line SL in accordance with the drive control signal.

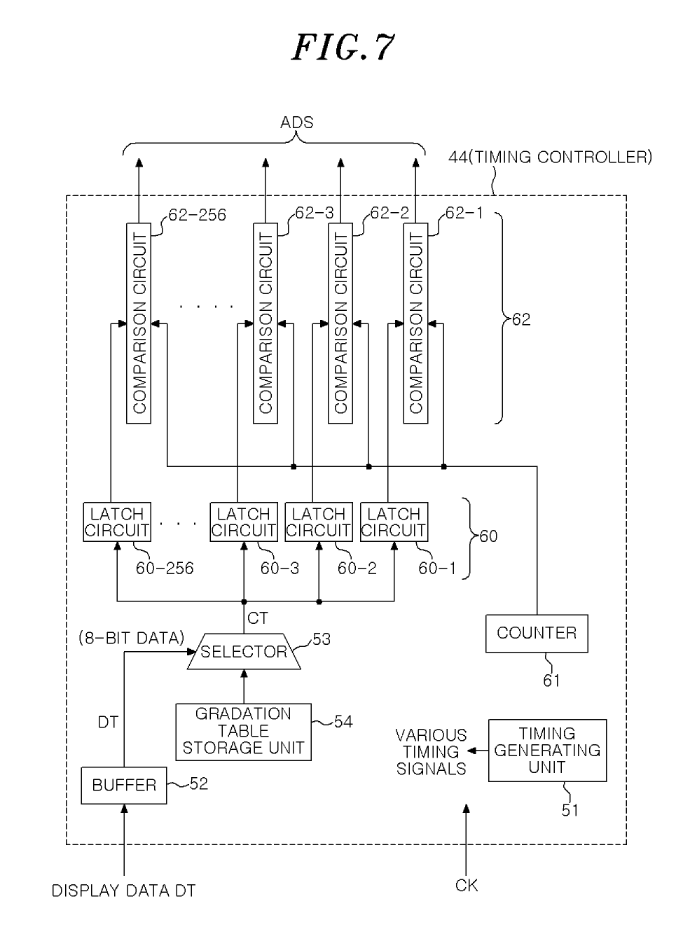

FIG. 7 shows a specific configuration example of the timing controller 44. The timing controller 44 inputs the display data DT stored in the aforementioned display data storage unit 32 into a buffer 52 in the unit of a single line and generates the drive control signal ADS. The buffer 52 is used to buffer (temporally store) the display data DT (display data of 256 pixels) of a single line read out from the display data storage unit 32. The display data DT is, e.g., data indicating 256 gradations (0/255 to 255/255) with 8 bits per pixel.

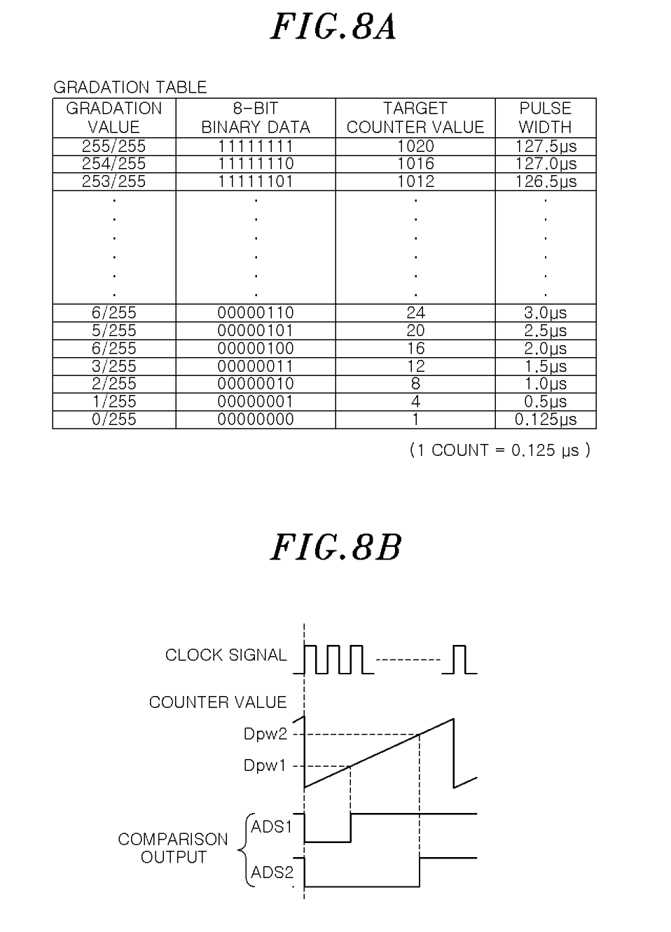

The display data DT of the buffered single line, i.e., the display data of the 256 pixels, is supplied to the selector 53 in the unit of a single pixel (8 bits). The selector 53 selects a target counter value stored in the gradation table storage unit 54 in accordance with the 8-bit gradations and outputs the selected target counter value. The gradation table stored in the gradation table storage unit 54 has a structure in which an 8-bit binary data and a target counter value are associated with each other, as shown in FIG. 8A, for example. In FIG. 8A, a gradation value and a pulse width are additionally shown for reference. However, they are not necessarily stored as an actual table data. The gradation values 0/255 to 255/255 correspond to 256 gradations expressed by 8-bit binary data 00000000 to 11111111. 0/255 (=00000000) is a gradation value of black having the lowest luminance and instructs non-emission of pixels. 1/255 (=00000001) to 255/255 (=11111111) instruct emission of pixels. 255/255 is a gradation value of white having the highest luminance. The pulse width as a data line drive signal controlled by the target counter value is expressed as a time value and corresponds to a time period of the constant current output of the anode driver 33. In this example, it is assumed that a target counter value 1 corresponds to 0.125 μs. For example, when the target counter value is 1020, the pulse width is 127.5 μs.

In the present embodiment, a target counter value corresponding to a gradation value 0/255 is set to 1. The gradation value 0/255, i.e., the display data expressed by 00000000, instructs non-emission. Therefore, the target counter value is generally set to 0 and the anode driver 33 does not output the constant current to the data line DL of the pixels having the gradation value 0/255. However, in the present embodiment, the target counter value is set to 1, so that the constant current is supplied to the non-emitted pixels for, e.g., 0.125 μs. Since the setting of the target counter value to 1 is merely an example, the target counter value may be set to 2 or 3.

In the configuration shown in FIG. 7, by referring to the gradation table, the selector 53 reads out and outputs the target counter value CT in accordance with the display data DT expressed as an 8-bit binary data. For example, when the 8-bit display data is 11111101 (253/255 gradation), the target counter value 1012 is outputted. The target counter value CT is obtained by converting the gradation value of the display data DT to a value for controlling the actual current supply time period. The target counter value CT outputted from the selector 53 is latched to the latch circuits 60 (60-1 to 60-256).

There are provided a plurality of latch circuits 60 (60-1 to 60-256 in this example) corresponding to the pixels on a single line. The target counter values CT of the respective pixels on a single line are latched to the latch circuits 60 corresponding thereto. Therefore, the target counter values CT of the respective pixels on a single line are respectively latched to the latch circuits 60-1 to 60-256. In comparison circuits 62 (62-1 to 62-256), the target counter values CT latched to the latch circuits 60-1 to 60-256 are compared with count values of a counter 61. As the result of comparison, the drive control signal ADS for each data line DL can be obtained.

This operation will be described with reference to FIG. 8B. The counter 61 repeats count-up to a predetermined maximum value in accordance with a predetermined clock signal. The predetermined maximum value is set to a value corresponding to a period of a single scanning line SL. The output of the comparison circuit 62 is decreased to an L level at a counter value reset timing. When the counter value reaches the latched target counter value CT, the output of the comparison circuit 62 is increased to an H level. For example, when the target counter value CT latched to a certain latch circuit 60-x is Dpw1, a drive control signal ADS1 can be obtained as a comparison output from the comparison circuit 62-x. When the target counter value CT latched to a certain latch circuit 60-y is Dpw2, a drive control signal ADS2 can be obtained as a comparison output from the comparison circuit 62-y. The outputs of the comparison circuits 62-1 to 62-256 are pulses whose time periods are set based on the target counter values CT latched to the latch circuits 60-1 to 60-256 corresponding thereto. The comparison outputs are supplied as the drive control signals ADS for the respective data lines DL1 to DL256 to the anode driver 33. As described with reference to FIG. 3, the anode driver 33 outputs the constant current (data line drive signal) to the data lines DL1 to DL256 during the L level of the pulses of the drive control signals. Accordingly, the constant current is outputted to the respective data lines DL for a time period corresponding to the gradation in the display data DT.

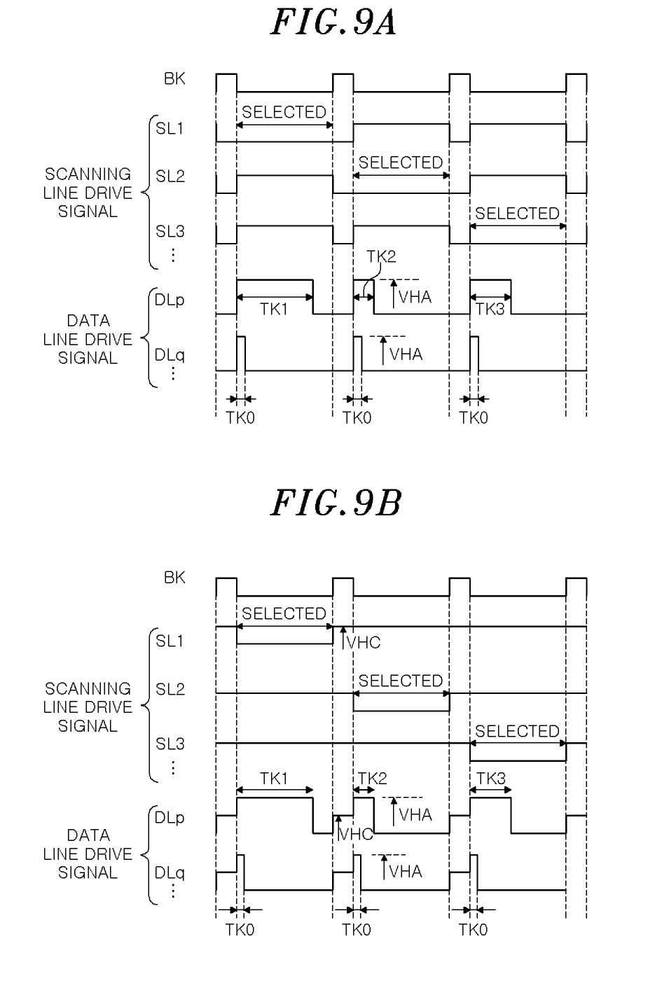

With this configuration, in the present embodiment, the anode driver 33 supplies the constant current as the data line drive signal outputted to the data lines DL to the non-emitted pixels for a short time period. FIG. 9A shows examples of scanning line drive signals and data line drive signals. The scanning line drive signals are applied from the cathode driver 21 to the scanning lines SL1 to SL3. When the scanning line drive signals are kept at an L level, the scanning lines are selected. The blanking signal BK specifies timing (blanking period) at which all the pixels do not emit light. FIG. 9A shows an example of so-called “L blanking drive” in which all of the scanning lines SL and the data lines DL are kept at an L level during the blanking period that is the H-level period of the blanking signal BK. During the blanking period, the constant current as the data line drive signal is not supplied.

The scanning lines SL1, SL2, . . . are sequentially selected by the scanning line drive signals. The scanning lines SL are selected by applying the scanning line drive signals of an L level thereto. Here, a data line DLp supplies the constant current to the pixels on the selected scanning line SL which emit light at gradations specified by the display data DT. The constant current is supplied as the data drive signal to the data line DLp for time periods TK1, TK2 and TK3 corresponding to the gradations of the pixels on the selected scanning line SL. The pulse waveform shown in the drawing is the output terminal voltage of the anode driver 33. The pulse waveform indicates the constant current supply period. The H level pulse period, i.e., the period in which the output terminal voltage of the anode driver 33 for the data line DLp is VHA (see FIGS. 2 and 3), is the light emission period of each pixel. The gradation is expressed by the length of the H level pulse period.

The data line DLq is connected to non-emitted pixels on the scanning lines SL1 to SL3 which have the gradation 0/255 in the display data DT. In general, the constant current is not applied to the data line DLq. However, in the present embodiment, the constant current is supplied to the data line DLq for a predetermined period (non-emission time period TK0) as illustrated. In other words, the output terminal voltage of the anode driver 33 for the data line DLq is VHA. The constant current supply for the non-emission time period TK0 is started when the constant current supply to the data line DLp connected to emitted pixels is started. This is because the target counter value CT corresponding to the display data 00000000 (=0/255 gradation) is set to 1 as shown in FIG. 8A. By setting the target counter value CT to 1, the constant current is applied to the non-emitted pixels for the non-emission time period TK0, e.g., 0.125 μs, despite that the gradation value specified by the display data DT indicates non-emission.

By applying the constant current to the non-emitted pixels for the non-emission time period TK0, the luminance unevenness described in FIG. 4 can be suppressed. The state shown in FIG. 5B is obtained at the lighting start timing and the state shown in FIG. 5C is obtained after the non-emission time period TK0 elapses. The state shown in FIG. 5B occurs momentarily. In other words, the parasitic capacitance of the non-emitted pixels is charged and the load for charging the parasitic capacitance of the non-emitted pixels is reduced when the state shown in FIG. 5C is obtained. Therefore, the build-up of the light-emitting drive current on the line having a low lighting ratio is improved. As a consequence, the light-emitting drive current has a waveform indicated by a solid line in FIG. 5A regardless of the lighting ratio of the line. As a result, the luminance unevenness shown in FIG. 4 is suppressed.

The current does not flow through the non-emitted pixels. In other words, the non-emitted pixels do not emit light and have the luminance of zero. If the non-emitted pixels emit light by the current made to flow therethrough, the 0/255 gradation does not exist and this leads to poor gradation display and hence the deterioration of the display quality. To that end, in the present embodiment, the non-emission time period TK0 in which the current is supplied to the non-emitted pixels is set to be considerably short. In other words, the lighting is hardly recognized during the non-emission time period TK0. Although the non-emission time period may be set variously, it is set to be at least shorter than the constant current supply period of the 1/255 gradation (e.g., 0.5 μs. in the example of FIG. 8A). If not, the 0/255 gradation does not exist. Further, the non-emission time period is preferably set to be at least shorter than or equal to a half of the constant current supply period of the 1/255 gradation. Such a time period can be recognized as non-emission and enables the gradation levels to be clearly divided.

Although there are the effects of the current value, the light emission efficiency of the pixel or the like, it is actually difficult for a human to recognize light emission for 1 μs or less. Therefore, it is preferable to set the non-emission time period TK0 to be at least shorter than or equal to fps. For example, when the gradation is set to a small number of levels, e.g., 16 levels (0/15 to 15/15), the constant current supply period of the gradation 1/15 may be 6 μs to 7 μs. In that case, the non-emission time period TK0 is preferably shorter than or equal to 1 μs.

### 4. Second Embodiment

Hereinafter, a second embodiment will be described. The second embodiment shows an example of a driving method in which the scanning lines SL and the data lines DL are set to a specific potential state (voltage VHC in this example) during the blanking period as shown in FIG. 9B, instead of the L blanking drive shown in FIG. 9A. As illustrated, during the blanking period that is the H-level period of the blanking signal BK, all the scanning lines SL and the data lines DL are set to the voltage VHC and the supply of the constant current as the data line drive signal is stopped. After the blanking period is terminated, the constant current is supplied to the data line DLp for time periods corresponding to the gradations of the pixels on the selected scanning line SL while setting the output terminal voltage of the anode driver 33 to VHA (VHC<VHA). At the same time, the constant current is supplied to the data line DLq for the non-emission time period TK0 while setting the output terminal voltage of the anode driver 33 to VHA.

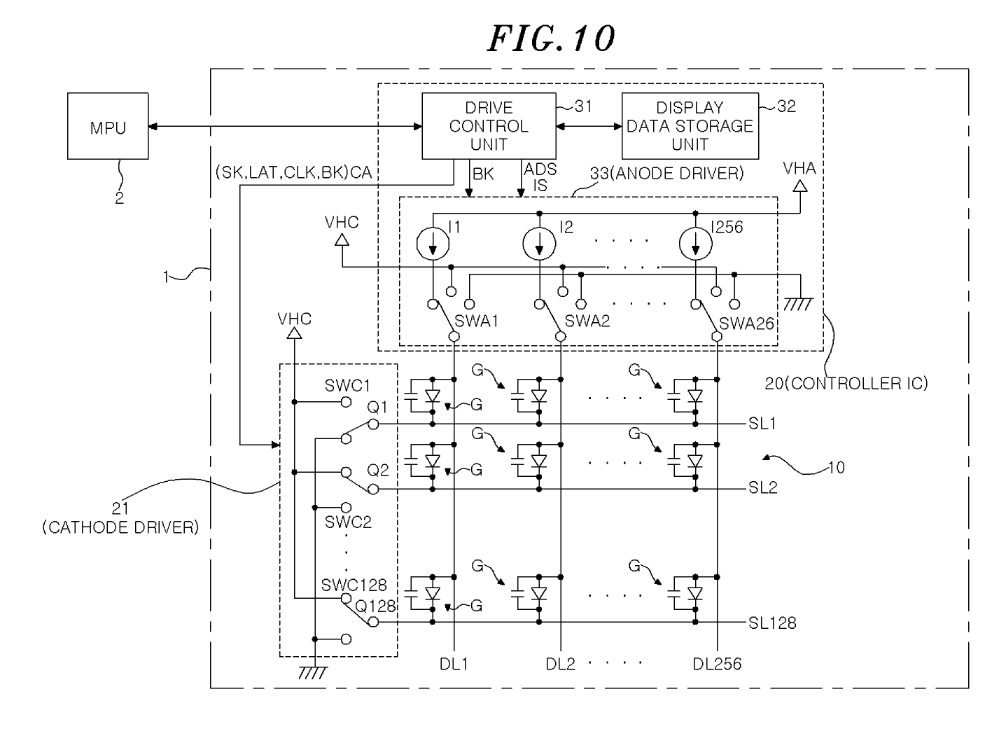

The configuration example of the second embodiment is shown in FIG. 10. FIG. 10 shows, as an equivalent circuit, the configuration of the display unit 10, the anode driver 33, and the cathode driver 21, which is similar to that shown in FIG. 2. Like reference numerals will be used for like parts in FIG. 2. The redundant description thereof will be omitted. In this case, in the anode driver 33, the data lines DL1 to DL256 are selectively connected to three systems through the respective switches SWA1 to SWA256. In other words, the switches SWA1 to SWA256 allow the data lines DL (DL1 to DL256) to be connected to one among the constant current sources I1 to I256, the ground, and the voltage VHC. Further, the blanking signal BK is supplied from the drive control unit 31 to the anode driver 33 and the switches SWA1 to SWA256 allows the data lines DL1 to DL256 to be connected to the voltage VHC during the blanking period. In the cathode driver 21, the switches SWC1 to SWC128 are selected to be connected to the voltage VHC during the blanking period, so that the scanning line drive signal is at an H level (=VHC).

The other configurations of the second embodiment are the same as those of the first embodiment. As in the case shown in FIG. 9A, when the data line DLp of FIG. 9B is connected to the emitted pixels, the constant current is supplied as the data line drive signal to the data line DLp for time periods TK1 to TK3 corresponding to the gradations of the respective pixels on the selected scanning line SL. Further, the data line DLq is connected to non-emitted pixels on the scanning lines SL1 to SL3 which have the gradation 0/255 in the display data DT. In this case, the target counter value CT corresponding to the display data 00000000 (=0/255 gradation) is set to 1 as in the case shown in FIG. 8A, so that the constant current is applied to the non-emitted pixels for, e.g., the non-emission time period (TK0=0.125 μs). Accordingly, as in the first embodiment, the luminance unevenness is suppressed.

### 5. Third Embodiment

In a third embodiment, the gradation table stored in the gradation table storage unit 54 shown in FIG. 7 is rewritten by the command from the MPU 2. Specifically, the MPU 2 issues a gradation table setting command and delivers the gradation table to the controller IC 20 so that it can be updated.

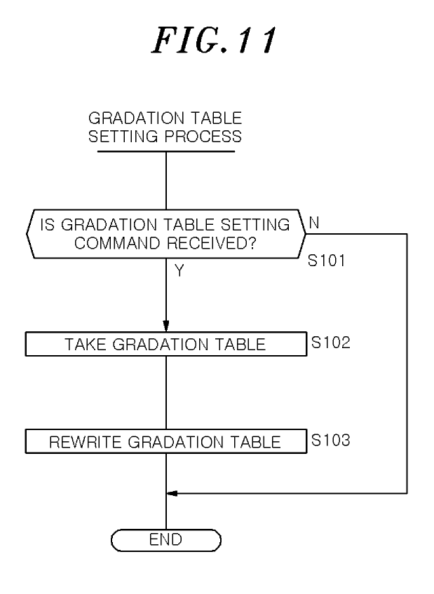

FIG. 11 shows processes executed by the controller IC 20 (the drive control unit 31) in response to the gradation table setting command delivered from the MPU 2. In a step S101, the drive control unit 31 monitors the gradation table setting command. If the gradation table setting command is received, the flow proceeds to a step S102 where the drive control unit 31 takes the gradation table. In a step S103, the drive control unit 31 rewrites the gradation table storage unit 54 in the anode driver 33. Accordingly, the gradation table is updated by another gradation table in which the pulse widths corresponding to the gradation values are different.

Specifically, the gradation table is updated by another gradation table in which the target counter value CT corresponding to the 0/255 gradation (=00000000) is different. In other words, the MPU prepares a plurality of gradation tables in which the target counter values CT corresponding to 1/255 gradation to 255/255 gradation are the same and the target counter value CT corresponding to the 0/255 gradation is different, and provides a selected gradation table to the controller IC 20.

Accordingly, the constant current supply period for the non-emitted pixels can be finely controlled. For example, the appropriate non-emission time period varies depending on the panel size, the number of pixels on a single line, or the like. Therefore, the non-emission time period is flexibly varied by changing the gradation table depending on a panel to be connected. In addition, another gradation table in which the target counter values CT corresponding to 0/255 gradation to 255/255 gradation are different may be provided and used for updating.

### 6. Fourth Embodiment

Next, a fourth embodiment will be described. In the first to the third embodiment, the constant current is supplied to all of the non-emitted pixels for the non-emission time period. However, the constant current may be supplied to a part of the non-emitted pixels.

As in the first to the third embodiment, it is effective in reducing the luminance unevenness to supply the constant current to all of the data lines DL of the non-emitted pixels for the non-emission time period. However, this may lead to an increase of noise depending on types of devices. Therefore, it is considered to supply the constant current to a part of the data lines Dl of the non-emitted pixels for the non-emission time period. For example, the constant current is supplied to (approximately) a half of the non-emitted pixels for the non-emission time period. This makes is possible to suppress the generation of noise while reducing the luminance unevenness. Further, the power consumption can be reduced due to the reduction of the number of pixels to which the current is supplied.

Particularly, it is preferable to uniformly arrange the data lines DL of the non-emitted pixels to which the constant current is supplied at a regular interval on a single screen. Here, the term “uniformly” specifically denotes a state in which the constant current is applied to every other pixel in a single line and pixels to which the constant current is supplied and pixels to which the constant current is not applied are adjacent to each other in the adjacent lines. In other words, the non-emitted pixels to which the constant current is supplied and the non-emitted pixels to which the constant current is not supplied are arranged in a matrix shape on the screen.

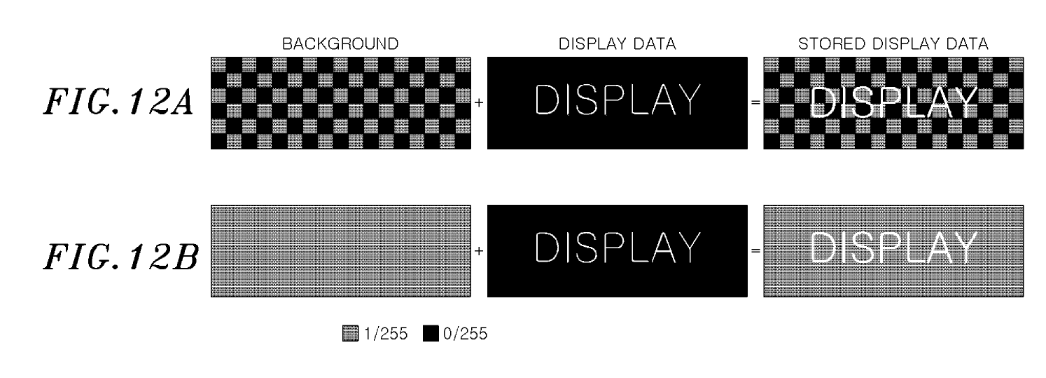

To do so, it may be considered to combine an original display data DT and a background image data in which the gradation value 0/255 and the gradation value 1/255 are alternately arranged in the vertical and horizontal directions. FIG. 12A schematically shows an example of the display data DT. FIG. 12A shows a combined image of the display data having an image expressed as “DISPLAY” of a certain gradation value and the background data in which the gradation value 1/255 and the gradation value 0/255 are alternately arranged in a matrix shape. In this case, the pixels having the gradation value 1/255 and the pixels having the gradation value 0/255 are arranged in a matrix shape at the background portion originally having non-emitted pixels in the display data DT stored in the display data storage unit 32 of the controller IC 20.

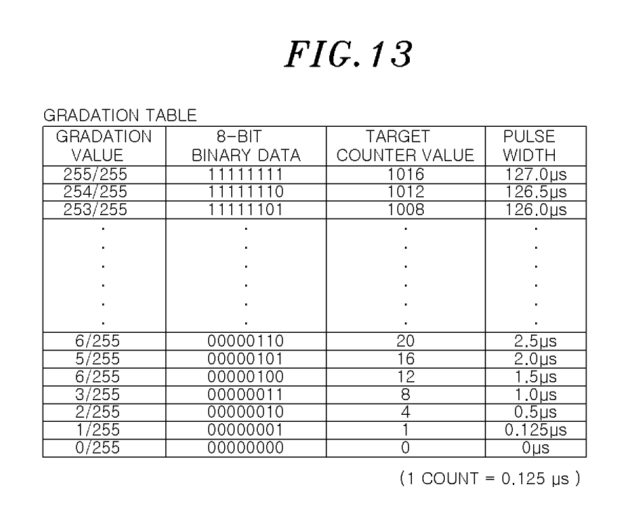

The gradation table shown in FIG. 13 is stored in the gradation table storage unit 54 of the timing controller 44. In this gradation table, the target counter value CT corresponding to the gradation value 0/255 is set to 0. In other words, the current is not supplied. The target counter value CT corresponding to the gradation value 1/255 is set to 1. In other words, the current is supplied for a period of 0.125 μs. As a consequence, in the combined display data illustrated at the right side of FIG. 12A, the current is supplied to approximately a half of the non-emitted pixels for the non-emission time period (0.125 μs in this case) and is not supplied to the other half of the non-emitted pixels.

Therefore, it is preferable to combine the display data DT and the background data shown in FIG. 12A before the display data DT is supplied to the controller IC 20 by the MPU 2. In other words, the MPU 2 converts the gradation value of the display data DT so that the constant current can be supplied to a part of the pixels having non-emission gradation values specified by the display data DT for the non-emission time period by the anode driver 33, and then supplies the converted display data DT to the controller IC (the drive control unit 31). Accordingly, the constant current can be supplied to approximately a half of the non-emitted pixels. As a result, the noise generated by supplying the constant current for a short period of time can be suppressed.

Instead of the data conversion in the MPU 2, the combination of the received display data DT and the background data shown in FIG. 12A may be performed by a background data combining unit provided in the drive control unit 31 of the controller IC 20. Then, the combined display data DT may be stored in the display data storage unit 32. Accordingly, the anode driver 33 drives the data lines DL such that the constant current is supplied to a part of the pixels having non-emission gradation values specified by the original display data DT for the non-emission time period. Or, the display data DT and the background data shown in FIG. 12A may be combined in the step of reading out the display data DT from the display data storage unit 32 by the timing controller 44 and the combined display data DT of 8 bits may be supplied to the selector 53. In that case, the anode driver 33 drives the data lines DL such that the constant current is supplied to a part of the pixels having non-emission gradation values specified by the original display data DT for the non-emission time period.

In the above description, the constant current is supplied to approximately a half of the non-emitted pixels. However, it is not necessary to supply the constant current to a half of the non-emitted pixels. This is because the proportion for optimal reduction of the luminance unevenness and optimal reduction of the noise level (proportion of non-emitted pixels to which the constant current is supplied) varies depending on design specifications such as the size of the display panel, the number of pixels of a single line and the like. Therefore, it is preferable to examine an appropriate proportion for each display device.

FIG. 12B shows a combined image of the display data having an image expressed as “DISPLAY” of a certain gradation and the background data having the gradation value 1/255. In this case, the display data stored in the display data storage unit 32 of the controller IC 20 is the display data having an image expressed as “DISPLAY” of the gradation in the background of the gradation value 1/255. When the MPU 2 supplies the converted display data DT to the controller IC 20, the constant current is supplied to all of the non-emitted pixels for the non-emission time period in the case of using the gradation table shown in FIG. 13. In other words, it is possible to perform the same operation as that in the first embodiment through the display data conversion of the MPU 2 side.

### 7. Summary and Modification

The above embodiments can provide the following effects. The display driving device (the controller IC 20) of the above embodiments performs display driving based on the display data on the display unit 10 in which the data lines DL connected to a plurality of pixels arranged in a column direction and the scanning line SL connected to a plurality of pixels arranged in a row direction are disposed and in which the pixels are arranged at intersections of the data lines DL and the scanning lines SL. The display driving device (the controller IC 20) includes the data line driving unit (the timing controller 44 and the anode driver 33) that supplies the constant current to the data lines DL for time periods corresponding to the gradation values of the pixels specified by the display data DT whenever the scanning lines SL are selected. The data line driving unit drives the data lines DL such that the constant current is supplied to all or a part of the pixels having the non-emission gradation value 0/255 specified by the display data DT for the non-emission time period.

Specifically, even when the display data DT has the 0/255 gradation, the target counter value CT is converted to 1 so that the current can be supplied. In general, the constant current is not supplied to the non-emitted pixels (the data lines connected to the non-emitted pixels) and, thus, the non-emitted pixels are in a non-emission state. However, in the present embodiment, the constant current is supplied to the data lines DL of the non-emitted pixels for a certain time period (non-emission time period). Accordingly, the start of the data line drive signal by the charging of the parasitic capacitance of the non-emitted pixels is not greatly affected by the number of non-emitted pixels (lighting ratio) on a single line. As a result, the build-up of the luminance can become substantially uniform regardless of the lighting ratio, and the luminance unevenness can be reduced or eliminated. Further, by supplying the constant current to a part of the non-emitted pixels for the non-emission time period as described in the fourth embodiment, it is possible to suppress the noise while reducing or eliminating the luminance unevenness.

The non-emission time period is fixed certain time period. For example, when the target counter value CT is 1, the non-emission time period is 0.125 μs. In other words, regardless of the positions of the pixels in the display unit 10, the scanning lines, the data lines or the like, the constant current is supplied to the pixels having non-emission gradation values in the display data for the same time period as the non-emission time period. Since the constant current is supplied only to the pixels having the non-emission gradation values for the specific non-emission time period, the circuit configuration or control is simplified. Specifically, the operation of the present embodiment can be realized by the setting of the gradation table (the setting of the target counter value CT corresponding to the 0/255 gradation). Thus, the circuit change or the like is not required and the implementation cost can be reduced, which is practical.

Further, the non-emission time period is set to be shorter than the constant current supply time period (e.g., 0.5 μs in FIG. 8A) for the pixels having the lowest gradation (1/255) among the light emission instruction values in the display data. By supplying the constant current to the non-emitted pixels, the non-emitted pixels actually emit light. Therefore, the non-emission time period is set to be shorter than the constant current supply time period for the emitted pixels such that it is hardly recognized as lighting. Accordingly, the drive for the non-emitted pixels and the drive for the emitted pixels are distinguished from each other. As a result, the gradations between the non-emitted pixels and the emitted pixels are not deteriorated and the display quality is maintained at a high level.

Moreover, the non-emission time period is set to be shorter than or equal to a half of the constant current supply period for the pixels having the lowest gradation (1/255) among the lighting instruction value in the display data. In the example shown in FIG. 8A, the non-emission time period is set to be 0.125 μs that is a half of 0.5 μs. In view of the display quality, the constant current supply period for the non-emitted pixels should be set such that it is visually recognized as non-emission. In the case of the lowest gradation among the lighting state, the non-emission time period is set to be shorter than a half of the constant current supply period such that it is visually recognized as non-emission. Accordingly, the gradations between the non-emitted pixels and the emitted pixels are not deteriorated and the display quality is maintained at a high level.

As described in the third embodiment, the non-emission time period (i.e., the target counter value CT corresponding to the 0/255 gradation in the gradation table) can be changed by the external command. Since the non-emission time period can be updated by the external command, the non-emission time period can be controlled depending on, e.g., the display unit. Accordingly, the non-emission time period can be controlled to an optimal length. This enables the component as the controller IC 20 to be widely used.

As described in the fourth embodiment, the constant current can be supplied to all or a part of the non-emitted pixels for the non-emission time period by the conversion of the display data at the MPU 2 (display operation control unit) side. When it is difficult to update the gradation table by the controller IC 20 or when the gradation table should not be updated, the luminance unevenness can be reduced by processing the display data DT at the MPU 2 side.

While the embodiments have been described, the display apparatus or the display driving device of the disclosure is not limited to the above-described embodiments and may be variously modified. For example, in the above description, the controller IC 20 shown in FIG. 1 has therein the anode driver 33 as an example of the display driving device. However, the anode driver 33 may be separately provided. In addition, the controller IC 20 may have therein both of the anode driver 33 and the cathode driver 21.

When the controller IC 20 is used for a specific display panel exclusively, the gradation table may be stored as unrewritable ROM data. Further, when the gradation table is not used and the display data serves as the information indicating non-emission, there may be employed various configurations in which the current is supplied to the data lines DL for a predetermined non-emission time period. Moreover, the disclosure may be applied not only to a display apparatus using an OLED but also to other types of display apparatuses. Particularly, the disclosure is very suitable for a display apparatus using an element that emits light by current driving.

While the disclosure has been shown and described with respect to the embodiments, it will be understood by those skilled in the art that various changes and modifications may be made without departing from the scope of the disclosure as defined in the following claims.

What is claimed is:

1. A display driving device for performing display drive based on display data on a display unit in which data lines connected to a plurality of pixels arranged in a column direction and scanning lines connected to a plurality of pixels arranged in a row direction are disposed and in which the pixels are arranged at respective intersections of the data lines and the scanning lines, the display driving device comprising:
a data line driving unit configured to supply a constant current to the data lines for time periods corresponding to gradation values of pixels specified by the display data whenever the scanning lines are selected,
wherein the data line driving unit drives the data lines such that the constant current is supplied to all or a part of pixels, of which gradation values specified by the display data indicate non-emission, for a non-emission time period.

2. The display driving device of claim 1, wherein the non-emission time period is a fixed time period.

3. The display driving device of claim 1, wherein the non-emission time period is shorter than a constant current supply period for pixels having a lowest gradation among lighting instruction values in the display data.

4. The display driving device of claim 1, wherein the non-emission time period is shorter than or equal to a half of the constant current supply period for pixels having a lowest gradation among lighting instruction values in the display data.

5. The display driving device of claim 1, wherein the non-emission time period varies depending on an external command.

6. A display apparatus comprising:
a display unit in which data lines connected to a plurality of pixels arranged in a column direction and scanning lines connected to a plurality of pixels arranged in a row direction are disposed and in which the pixels are arranged at respective intersections of the data lines and the scanning lines;
a display driving unit configured to drive the data lines based on a display data; and
a scanning line driving unit configured to apply a scanning line drive signal to the scanning lines,
wherein the display driving unit includes a data line driving unit configured to supply a constant current to the data lines for time periods corresponding to gradation values of pixels specified by the display data,
wherein the data line driving unit drives the data lines such that the constant current is supplied to all or a part of pixels, of which gradation values specified by the display data indicate non-emission, for a non-emission time period.

7. A display drive method for performing display drive based on display data on a display unit in which data lines connected to a plurality of pixels arranged in a column direction and scanning lines connected to a plurality of pixels arranged in a row direction are disposed and in which the pixels are arranged at respective intersections of the data lines and the scanning lines, the display drive method comprising:
driving the data lines such that a constant current is supplied to the data lines for time periods corresponding to gradation values of pixels specified by a display data whenever the scanning lines are selected and also supplied to all or a part of pixels, of which gradation values specified by the display data indicate non-emission, for a non-emission time period.

8. A display apparatus comprising:
a display unit in which data lines connected to a plurality of pixels arranged in a column direction and scanning lines connected to a plurality of pixels arranged in a row direction are disposed and in which the pixels are arranged at respective intersections of the data lines and the scanning lines;
a scanning line driving unit configured to apply a scanning line drive signal to the scanning lines;
a display driving unit including a data line driving unit configured to supply a constant current to the data lines for time periods corresponding to gradation values of pixels specified by a display data whenever the scanning lines are selected; and
a display operation control unit configured to supply the display data to the display driving unit,
wherein the display operation control unit converts the gradation values of the display data and supplies the converted gradation values to the display driving unit so that the data line driving unit supplies the constant current to all or a part of the pixels, of which gradation values specified by the display data indicate non-emission, for a non-emission time period.
